(19) United States
(12) Patent Application Publication
(10) Pub. No.: US 2006/0274740 A1
(43) Pub. Date: Dec. 7, 2006

(54) Method and apparatus for business to consumer channeling over wireless access networks

(75) Inventors: Raj Savoor, Walnut Creek, CA (US); Steve Sposato, Lafayette, CA (US); Sam Ou, San Ramon, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/144,255

(22) Filed: Jun. 3, 2005

(51) Int. Cl. H04L 12/56

(52) U.S. Cl. 370/389

(57) ABSTRACT

A network service provider (NSP) (101) has a communications interface (102) coupled to one or more wireless access networks (120) and one or more content service providers (CSPs) (110), a memory (104), and a processor (106). The processor can be programmed to establish (202) a content profile for each of the wireless access networks according to one or more attributes of the wireless access networks and the CSPs, receive (204) a content access request from one or more selective call radios (SCRs) at one among the wireless access networks, and supply (206) each SCR content from one or more of the CSPs according to the content profile.

### FIELD OF THE INVENTION

This invention relates generally to content services, and more particularly to a method and apparatus for business to consumer channeling over wireless access networks.

### BACKGROUND OF THE INVENTION

The number of publicly accessible wireless access networks has grown substantially over the years. Many retailers are providing such services as a means to draw patrons to their locations, thereby encouraging additional business. Retailers generally employ service providers such as, for example, SBC Communications or other like carriers, to provide wireless services (e.g., IEEE 802.11 a/b/g/n).

Consumers who take advantage of such services by way of a wireless PDA (Personal Digital Assistant), a cell phone, or wireless laptop can interact on the Internet with conventional browsers. Generally, service providers of wireless access networks provide content to consumers in ad hoc fashion with poorly managed data or revenue mining. A need therefore arises for a method and apparatus for business to consumer channeling over wireless access networks.

### SUMMARY OF THE INVENTION

Embodiments in accordance with the invention provide a method and apparatus for business to consumer channeling over wireless access networks.

In a first embodiment of the present invention, a network service provider (NSP) has a communications interface coupled to one or more wireless access networks and one or more content service providers (CSPs), a memory, and a processor. The processor can be programmed to establish a content profile for each of the wireless access networks according to one or more attributes of the wireless access networks and the CSPs, receive a content access request from one or more selective call radios (SCRs) at one among the wireless access networks, and supply each SCR content from one or more of the CSPs according to the content profile.

In a second embodiment of the present invention, a network service provider (NSP) has a computer-readable storage medium including computer instructions for establishing a content profile for each of the wireless access networks according to one or more attributes of the wireless access networks and the CSPs, receiving a content access request from one or more selective call radios (SCRs) at one among the wireless access networks, and supplying each SCR content from one or more of the CSPs according to the content profile.

In a third embodiment of the present invention, a network service provider (NSP) operates according to a method having the steps of establishing a content profile for each of the wireless access networks according to one or more attributes of the wireless access networks and the CSPs, receiving a content access request from one or more selective call radios (SCRs) at one among the wireless access networks, and supplying each SCR content from one or more of the CSPs according to the content profile.

### BRIEF DESCRIPTION OF THE DRAWINGS

FIG. 1 is block diagram of a network service provider operating in a communication system according to an embodiment of the present invention; and

FIGS. 2-3 depict flowcharts of a method operating in the network service provider according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

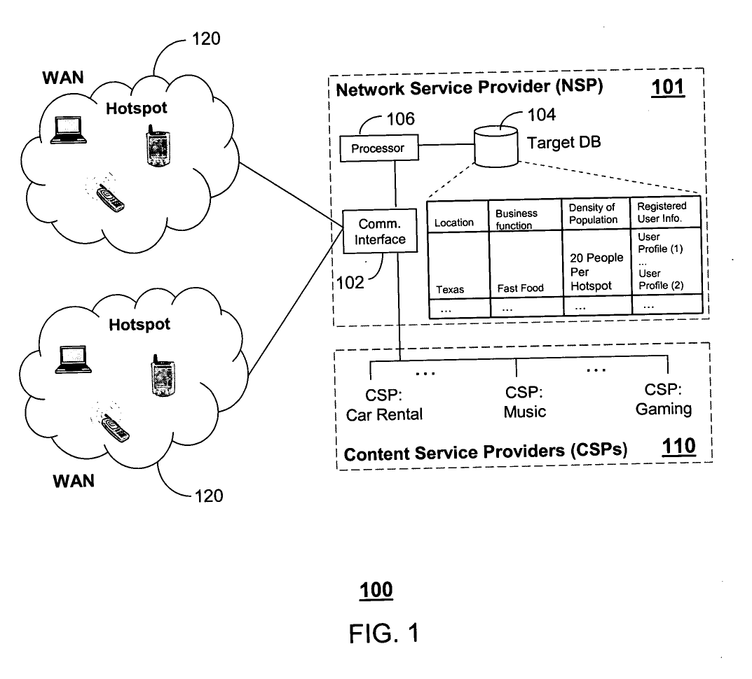

FIG. 1 is block diagram 100 of a network service provider (NSP) 101 operating in a communication system 100 according to an embodiment of the present invention. The NSP 101 comprises conventional technology such as a communications interface 102, a memory 104, and a processor 106. The processor 106 can utilize one or more conventional computers or servers for controlling operations of the NSP 101. The memory 104 utilizes one or more conventional media devices (such as a high capacity disk drive, Flash memory, Dynamic Random Access Memory, floppy disks, or other like memories) for storage purposes, and can be used for managing databases of a service provider of said system 101. The databases can be used for recording information pertinent to managing the communication system 100 such as, for example, billing information, services rendered, services pending, and content profiles (as will be described below), just to mention a few. Said databases can be managed by, for example, a conventional CRM (Customer Relations Management) system.

The communications interface 102 can comprise conventional technology for routing content between content service providers (CSPs) 110 and wireless access networks 120 under the control of the processor 106 in accordance with the present invention. CSPs 110 offer limitless services including, for instance, downloadable content services like music and gaming, travel services such as car rentals, airplane reservations, and so on. The wireless access networks 120 can provide access to these services by providing a wireless environment for connectivity.

Wireless access networks 120 can utilize conventional wireless technology such as IEEE 802.11 a/b/g/n or other like wireless technologies. Retailers can employ a service provider to install a wireless access network 120 (referred to as a hotspot in common parlance) to draw patrons who have wireless devices capable of communicating with the wireless access network 120. Such devices include, for example, a wireless PDA (Personal Digital Assistant), a cell phone, a laptop, or other suitable wireless device. Each of these devices are referred to herein as a selective call radio (SCR).

The SCRs utilize conventional browser technology (e.g., Microsoft Explorer, or microbrowsers) for searching and manipulating content accessed by way of the wireless access networks 120 on public networks such as the Internet or private/Intranet networks. It would be obvious to an artisan with skill in the art that any present or future conventional wireless technology for communicating with the wireless access networks 120 is suitable for the present invention. Similarly, data communication links between the wireless access networks 120 and CSPs 110 can use any conventional data protocol such as IP (Internet Protocol), ATM (Asynchronous Transfer Mode), FR (Frame Relay), MPLS (Multi-protocol label switching), or Ethernet, just to mention a few.

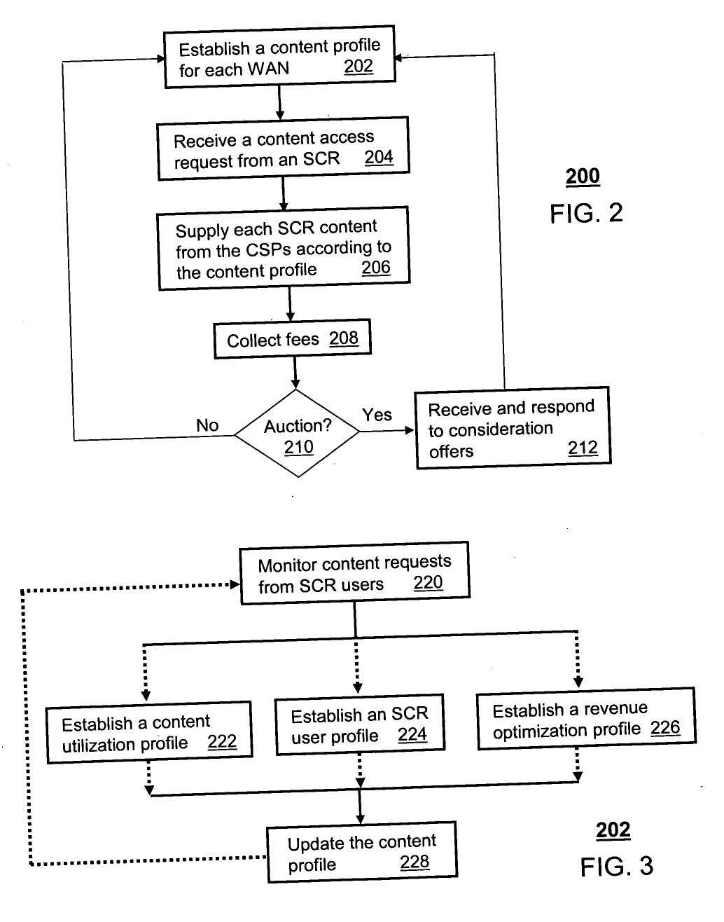

FIGS. 2-3 depict flowcharts of a method 200 operating in the NSP 101 according to an embodiment of the present invention. Method 200 provides a means for a service provider of the NSP 101 to manage distribution of content between the CSPs 110 and wireless access networks 120. Ownership of the wireless access networks 120 and/or CSPs 110 has no bearing on the operation of the NSPs 101 in accordance with the present invention. Thus, for the embodiment described below, an assumption can be made that the service provider of the NSP 101 owns and operates the wireless access networks 120, but not the CSPs 110. It would be obvious to an artisan with skill in the art that alternative business arrangements are possible without deviating from the scope of the invention.

With this in mind, method 200 begins with step 202 where the NSP 101 establishes a content profile for each wireless access network 120 according to one or more attributes of the wireless access networks 120 and CSPs 110. Wireless access network 120 attributes can be represented by any characteristics relevant to the operation of content delivery. For instance, a relevant wireless access network 120 attribute can be its location, its business function, a density of SCR users at the wireless access network 120 on average or at any particular time, a demographic profile of SCR users, and/or fees paid by retailers for the use of a wireless access network 120 at their place of business. Similarly, CSP 110 attributes can include, for example, a content type offered by each of the CSPs, and a presentation ranking of content from each CSPs determined according to fees offered and paid to the service provider of the NSP 101 for such ranking.

Any of the foregoing attributes can be analyzed by the NSP 101 to establish a content profile for each wireless access network 120. To illustrate this point, the reader's attention is referred back to FIG. 1. In this illustration, the NSP 101 can be programmed to analyze attributes stored in the database of the memory 104 to establish a content profile. In this depiction, a particular wireless access network 120 is shown to be situated in Tex. having a business function in the fast food services (e.g., McDonalds™) with an average density of 20 patrons per day. For such patrons, the NSP 101 can be programmed to supply content from select CSPs 110 according to demographic needs of patrons who frequent the establishment, service level agreements with the wireless access networks 120, and/or a presentation ranking of content according to fee arrangements with the CSPs 110 seeking to target these patrons.

It would be evident from the foregoing example to one of ordinary skill in the art that any method for establishing a content profile that can improve business for any one of the service provider of the NSP 101, retailers offering wireless services to its patrons through a wireless access network 120 located in their facility, and the CSPs 110 is suitable for the present invention. It would also be evident to said artisan that the content profile can be dynamically updated.

That is, by monitoring the behavior of SCR users while exploring content, a use behavior can be developed and exploited by dynamically adapting the content profile associated with each wireless access network 120. It should be apparent also that a content profile can be developed for each SCR user individually, thereby providing a means for micro-segmentation. In either case, the content profile can be continuously or periodically updated so as to optimize revenue opportunities for all parties including the retailers serviced by the wireless access network 120, the CSPs 110, and ultimately the service provider of the NSP 101.

FIG. 3 illustrates alternative embodiments for establishing dynamic content profiles. It would be obvious to an artisan with skill in the art that these embodiments are not limiting, and that other methods for establishing content profiles are possible, and are therefore considered to be within the scope and spirit of the claims described below.

In a first embodiment, step 202 breaks down into step 220 where the NSP 101 monitors content requests from SCR users at each of the wireless access networks 120. In this embodiment, a content utilization profile is established in step 222 for each of the wireless access networks 120 according to the monitored requests. The content utilization profile can be developed by any conventional pattern recognition technique such as statistical demographic and/or psychographic analysis of SCR users on the basis of the content they explore and purchase. In step 228 the content profile of each wireless access network 120 can be updated according to the content utilization profile. These steps provide a means to dynamically adapt the content profile of a wireless access network 120 as use behaviors evolves. The foregoing embodiment can be repeated as frequently as needed to remain up to date with trend cycles.

In an aggressive micro-segmentation embodiment, step 220 can be proceeded by step 224 where the NSP 101 establishes an SCR user profile according to the monitored requests. In this embodiment, each SCR can be uniquely identified by, for example, its MAC (Medium Access Control) address. A use behavior for each SCR user can be determined over the course of one or more sessions across one or more of the wireless access networks 120. As before, any technique for recognizing a patterned behavior can be used to hone in on the content and/or behavioral needs of each SCR user wherefrom an SCR user profile can be established. The SCR user profile can in turn be used in step 228 to update the content profile of the wireless access network 120, or a more targeted technique can be used whereby a content profile can be established for each SCR user.

Step 226 illustrates yet a third embodiment where the NSP 101 establishes a revenue optimization profile according to the requests monitored at the wireless access network 120. Any conventional method for mining revenue on the basis of observed behaviors of the SCR users can be used to develop this profile. Once developed, it can be used to update the content profile in step 228 similar to what has been described above.

Thus, the content profile developed in step 202 can be updated as a background process for each cycle of the flowchart of FIG. 2 according to the embodiments of FIG. 3 operating singly or in combination, or other embodiments not described herein, but within the scope of the present invention. Referring back to FIG. 2, the NSP 101 in step 204 receives and processes content requests from the SCRs. The requested content is supplied to each SCR in step 206 according the aforementioned embodiments of the content profile. The NSP 101 can also be programmed to collect fees from the CSPs 110 and the retailers utilizing the wireless access networks 120 according to static prearranged agreements (e.g., service level agreements) and/or dynamic fees collected according to behavior of SCR users.

Fees can be collected according to, for example, each occurrence of content presented to the SCRs, presentation of CSP 110 and/or wireless access network 120 advertising to the SCRs, presentation of CSP 110 and/or wireless access network 120 services to the SCRs, and/or content purchases made by SCR users—just to mention a few. It would be obvious to an artisan with skill in the art that any fee and/or revenue sharing arrangement between the service provider of the NSP 101 and the CSPs 110 and wireless access networks 120 can be applied to the present invention.

In yet another embodiment, the NSP 101 can auction the CSPs 110 access to consumers utilizing the wireless access networks 120. If auctioning is activated in step 210, the NSP 101 can be programmed to receive in step 212 fees offered by the CSPs 110 for access to these consumers, and can thereby respond according to predetermined business criteria established by the service provider of the NSP 101. Said criteria can be a simple algorithm such as supplying access according to the highest fee bid by the CSPs 110. Alternatively, more sophisticated criteria can be employed that factor in who is bidding, fees offered, customer satisfaction, service agreements with retailers, and so on.

It should be evident by now that the present invention can be realized in hardware, software, or a combination of hardware and software. Moreover, the present invention can be realized in a centralized fashion, or in a distributed fashion where different elements are spread across several interconnected processors. Any kind of computer device or other apparatus adapted for carrying out method 200 described above is suitable for the present invention.

Additionally, the present invention can be embedded in a computer program product, which comprises all the features enabling the implementation of method 200, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form. It should be also evident that the present invention may be used for many applications. Thus, although the description is made for particular arrangements and methods, the intent and concept of the invention is suitable and applicable to other arrangements and applications not described herein. For example, method 200 can be reduced to steps 202, 204, and 206 without departing from the claimed invention. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A network service provider (NSP), comprising:
a communications interface coupled to one or more wireless access networks and one or more content service providers (CSPs);
a memory; and
a processor, wherein the processor is programmed to:
establish a content profile for each of the wireless access networks according to one or more attributes of the wireless access networks and the CSPs;
receive a content access request from one or more selective call radios (SCRs) at one among the wireless access networks; and
supply each SCR content from one or more of the CSPs according to the content profile.

2. The NSP of claim 1, wherein the one or more attributes are at least one among a group of attributes comprising a location, a business function, a density of SCR users, a demographic profile of SCR users, and consideration for services received at each of the wireless access networks.

3. The NSP of claim 1, wherein the one or more attributes are at least one among a group of attributes comprising a content type offered by each of the CSPs, and a presentation ranking for each of the CSPs according to consideration offered thereby.

4. The NSP of claim 1, wherein the processor is programmed to:
monitor content requests from SCR users at each of the wireless access networks;
establish a content utilization profile for each of the wireless access networks according to the monitored requests; and
adjust the content profile of each of the wireless access networks according to its content utilization profile.

5. The NSP of claim 1, wherein the processor is programmed to:
monitor content requests from SCR users at each of the wireless access networks;
establish an SCR user profile for each SCR user according to the monitored requests; and
adjust the content profile of each of the wireless access networks according to the SCR user profiles.

6. The NSP of claim 1, wherein the processor is programmed to:
monitor content requests from SCR users at each of the wireless access networks;
establish a revenue optimization profile for each of the wireless access networks according to the monitored requests; and
adjust the content profile of each of the wireless access networks according to its revenue optimization model.

7. The NSP of claim 1, wherein the processor is programmed to:
auction access to consumers of at least one of the wireless access networks;
receive consideration offers from two or more of the CSPs for said access; and
respond to the consideration offers according to predetermined business criteria.

8. The NSP of claim 1, wherein the processor is programmed to collect consideration from at least one among the CSPs and the wireless access networks upon at least one among a group of events comprising presenting content to the SCRs, presenting CSP advertising to the SCRs, presenting wireless access network advertising to the SCRs, presenting CSP services to the SCRs, presenting wireless access network services to the SCRs, and SCR users purchasing content from the CSPs.

9. In a network service provider (NSP) a computer-readable storage medium, comprising computer instructions for:
establishing a content profile for each of the wireless access networks according to one or more attributes of the wireless access networks and the CSPs;
receiving a content access request from one or more selective call radios (SCRs) at one among the wireless access networks; and
supplying each SCR content from one or more of the CSPs according to the content profile.

10. The storage medium of claim 9, wherein the one or more attributes are at least one among a group of attributes comprising a location, a business function, a density of SCR users, a demographic profile of SCR users, and consideration for services received at each of the wireless access networks.

11. The storage medium of claim 9, wherein the one or more attributes are at least one among a group of attributes comprising a content type offered by each of the CSPs, and a presentation ranking for each of the CSPs according to consideration offered thereby.

12. The storage medium of claim 9, comprising computer instructions for:
monitoring content requests from SCR users at each of the wireless access networks;
establishing a content utilization profile for each of the wireless access networks according to the monitored requests; and
adjusting the content profile of each of the wireless access networks according to its content utilization profile.

13. The storage medium of claim 9, comprising computer instructions for:
monitoring content requests from SCR users at each of the wireless access networks;
establishing an SCR user profile for each SCR user according to the monitored requests; and
adjust the content profile of each of the wireless access networks according to the SCR user profiles.

14. The storage medium of claim 9, comprising computer instructions for:
monitoring content requests from SCR users at each of the wireless access networks;
establishing a revenue optimization profile for each of the wireless access networks according to the monitored requests; and
adjusting the content profile of each of the wireless access networks according to its revenue optimization model.

15. The storage medium of claim 9, comprising computer instructions for:
auctioning access to consumers of at least one of the wireless access networks;
receiving consideration offers from two or more of the CSPs for said access; and
responding to the consideration offers according to predetermined business criteria.

16. The storage medium of claim 9, comprising computer instructions for collecting consideration from at least one among the CSPs and the wireless access networks upon at least one among a group of events comprising presenting content to the SCRs, presenting CSP advertising to the SCRs, presenting wireless access network advertising to the SCRs, presenting CSP services to the SCRs, presenting wireless access network services to the SCRs, and SCR users purchasing content from the CSPs.

17. In a network service provider (NSP), a method comprising the steps of:
establishing a content profile for each of the wireless access networks according to one or more attributes of the wireless access networks and the CSPs;
receiving a content access request from one or more selective call radios (SCRs) at one among the wireless access networks; and
supplying each SCR content from one or more of the CSPs according to the content profile.

18. The method of claim 17, wherein the one or more attributes are at least one among a group of attributes comprising a location, a business function, a density of SCR users, a demographic profile of SCR users, consideration for services received at each of the wireless access networks, a content type offered by each of the CSPs, and a presentation ranking for each of the CSPs according to consideration offered thereby.

19. The method of claim 17, comprising the steps of:
monitoring content requests from SCR users at each of the wireless access networks;
establishing a content utilization profile for each of the wireless access networks according to the monitored requests; and
adjusting the content profile of each of the wireless access networks according to its content utilization profile.

20. The method of claim 17, comprising the steps of:
monitoring content requests from SCR users at each of the wireless access networks;
establishing a revenue optimization profile for each of the wireless access networks according to the monitored requests; and
adjusting the content profile of each of the wireless access networks according to its revenue optimization model.
